(19) United States
(12) Patent Application Publication
(10) Pub. No.: US 2020/0047487 A1
(43) Pub. Date: Feb. 13, 2020

(54) PRINTING APPARATUS, AND PRINTING METHOD

(71) Applicant: CANON KABUSHIKI KAISHA, Tokyo (JP)

(72) Inventors: Masahiro Sugimoto, Yokohama-shi (JP); Yuichiro Yanagi, Funabashi-shi (JP); Kohei Fukui, Hachioji-shi (JP); Ryosuke Hirokawa, Kawasaki-shi (JP)

(21) Appl. No.: 16/529,166

(22) Filed: Aug. 1, 2019

(30) Foreign Application Priority Data
Aug. 7, 2018 (JP) 2018-148721

(51) Int. Cl. B41J 2/005

(52) U.S. Cl. CPC B41J 2/0057

(57) ABSTRACT

There is provided with a printing apparatus. A transfer member rotates and moves cyclically. A transfer unit transfers an image formed on the transfer member to a print medium. A liquid absorbing unit absorbs a liquid component from the image on the transfer member. A liquid absorbing member has a first surface and a second surface. A liquid removal section includes a first rotating body and a second rotating body. A liquid removal section removes a liquid contained in the liquid absorbing member from a nipped portion by the first rotating body and the second rotating body. A liquid applying section applies a liquid to a position on the first surface. The position is on an upstream side of the nipped portion with respect to a direction of rotation and movement of the liquid absorbing member.

### BACKGROUND OF THE INVENTION

### Field of the Invention

The present invention relates to a printing apparatus, and a printing method.

### Description of the Related Art

A technique of forming an ink image on a transfer member and transferring it to a print medium such as paper is proposed. Japanese Patent Laid-Open No. 2018-089936 discloses a liquid absorbing member which absorbs a liquid component contained in an ink image formed on a transfer member. Japanese Patent Laid-Open No. 2018-089936 also discloses a technique of moisturizing the liquid absorbing member appropriately in order to prevent a degradation in liquid absorption performance of the liquid absorbing member due to thickening of the surface of the liquid absorbing member.

However, depending on the degree of repeated use of the liquid absorbing member, it is assumed that the liquid absorption performance cannot be maintained even if the method of Japanese Patent Laid-Open No. 2018-089936 is used.

### SUMMARY OF THE INVENTION

An embodiment of the present invention provides a technique of more effectively preventing a degradation in liquid absorption performance of a liquid absorbing member.

According to an embodiment of the present invention, a printing apparatus comprising: a transfer member configured to rotate and move cyclically; a transfer unit configured to transfer an image formed on the transfer member to a print medium; and a liquid absorbing unit configured to absorb a liquid component from the image on the transfer member before transfer by the transfer unit, wherein the liquid absorbing unit comprises: a liquid absorbing member configured to have a first surface contacting the image and a second surface opposite to the first surface; a moving unit configured to rotate and move the liquid absorbing member cyclically; a liquid removal section configured to include a first rotating body in contact with the first surface and a second rotating body in contact with the second surface, wherein the first rotating body and the second rotating body nip the liquid absorbing member, wherein the liquid removal section removes a liquid contained in the liquid absorbing member from a nipped portion by the first rotating body and the second rotating body; and a liquid applying section, arranged above the liquid absorbing member with respect to a gravitational direction, configured to apply a liquid to a position on the first surface, wherein the position is on an upstream side of the nipped portion with respect to a direction of rotation and movement of the liquid absorbing member.

According to another embodiment of the present invention, a printing method comprising: transferring an image formed on the transfer member to a print medium; absorbing a liquid by absorbing a liquid component from the image on the transfer member before transfer by the transferring, wherein the absorbing the liquid comprises: moving a liquid absorbing member to rotate and move cyclically; removing a liquid contained in the liquid absorbing member from a nipped portion by a first and a second rotating body, wherein the first rotating body contacts a first surface of the liquid absorbing member and the second rotating body contacts a second surface of the liquid absorbing member, wherein the first surface contacts the image and the second surface is opposite to the first surface, applying a liquid to a position on the first surface, wherein the position is on an upstream side of the nipped portion with respect to a direction of rotation and movement of the liquid absorbing member.

Further features of the present invention will become apparent from the following description of exemplary embodiments (with reference to the attached drawings).

### BRIEF DESCRIPTION OF THE DRAWINGS

FIG. 1 is a schematic view of a printing system which is a representative embodiment of the present invention;

FIG. 2 is a perspective view of a print unit;

FIG. 3 is an explanatory view of a displacement mode of the print unit in FIG. 2;

FIG. 4 is a block diagram of the control system of the printing system in FIG. 1;

FIG. 5 is a block diagram of the control system of the printing system in FIG. 1;

FIG. 6 is an explanatory view showing an example of the operation of the printing system in FIG. 1;

FIG. 7 is an explanatory view showing an example of the operation of the printing system in FIG. 1;

FIG. 8 is a schematic view of an absorbing unit;

FIG. 9 is an enlarged view of a portion A in FIG. 8;

FIG. 10 is a schematic view showing an example of a recovery unit;

FIG. 11 is a view schematically showing a relationship between the length in a widthwise direction of the liquid absorbing member and that of each component of the recovery unit;

FIGS. 12A and 12B schematically show the spread of a liquid at the time of applying the liquid, in which FIG. 12A is a view as seen from above and FIG. 12B is a view as seen from the widthwise direction;

FIG. 13 is a schematic view of an absorbing unit in a second embodiment;

FIG. 14 is a schematic view showing an example of a recovery unit in the second embodiment;

FIGS. 15A and 15B schematically show the spread of a liquid at the time of applying the liquid in the second embodiment, in which FIG. 15A is a view as seen from above and FIG. 15B is a view as seen from a widthwise direction; and

FIG. 16 is a schematic view of an absorbing unit in the third embodiment.

### DESCRIPTION OF THE EMBODIMENTS

Embodiments of the present invention will be described with reference to the accompanying drawings. In each view, arrows X and Y indicate horizontal directions perpendicular to each other. An arrow Z indicates a vertical direction.

### First Embodiment

<Printing System>

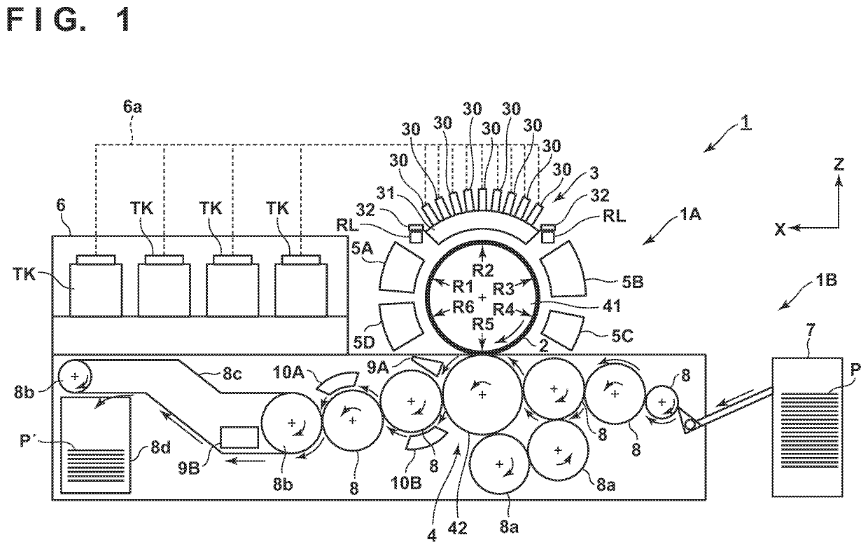

FIG. 1 is a front view schematically showing a printing system (printing apparatus) 1 according to an embodiment of the present invention. The printing system 1 is a sheet inkjet printer that forms (manufactures) a printed product P′ by transferring an ink image to a print medium P via a transfer member 2. The printing system 1 includes a printing apparatus 1A and a conveyance apparatus 1B. In this embodiment, an X direction, a Y direction, and a Z direction indicate the widthwise direction (total length direction), the depth direction, and the height direction of the printing system 1, respectively. The print medium P is conveyed in the X direction.

Note that “print” includes not only formation of significant information such as a character or graphic pattern but also formation of an image, design, or pattern on print media in a broader sense or processing of print media regardless of whether the information is significant or insignificant or has become obvious to allow human visual perception. In this embodiment, “print media” are assumed to be paper sheets but may be fabrics, plastic films, and the like.

An ink component is not particularly limited. In this embodiment, however, a case is assumed in which aqueous pigment ink that includes a pigment as a coloring material, water, and a resin is used.

<Printing Apparatus>

The printing apparatus 1A includes a print unit 3, a transfer unit 4, peripheral units 5A to 5D, and a supply unit 6.

<Print Unit>

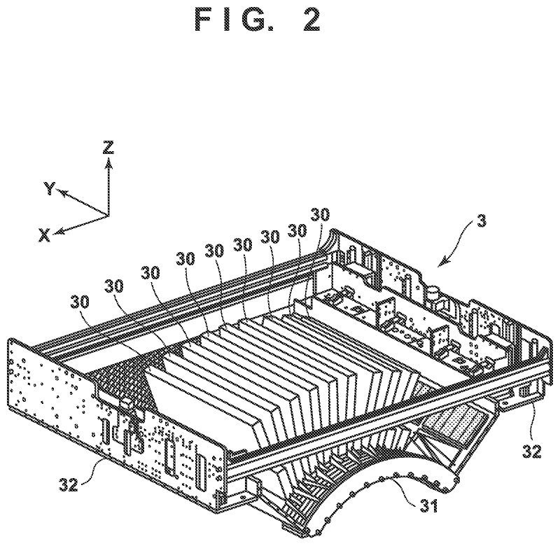

The print unit 3 includes a plurality of printheads 30 and a carriage 31. A description will be made with reference to FIGS. 1 and 2. FIG. 2 is perspective view showing the print unit 3. The printheads 30 discharge liquid ink to the transfer member 2 and form ink images of a printed image on the transfer member 2.

In this embodiment, each printhead 30 is a full-line head elongated in the Y direction, and nozzles are arrayed in a range where they cover the width of an image printing area of a print medium having a usable maximum size. Each printhead 30 has an ink discharge surface with the opened nozzle on its lower surface, and the ink discharge surface faces the surface of the transfer member 2 via a minute gap (for example, several mm). In this embodiment, the transfer member 2 is configured to move on a circular orbit cyclically, and thus the plurality of printheads 30 are arranged radially.

Each nozzle includes a discharge element. The discharge element is, for example, an element that generates a pressure in the nozzle and discharges ink in the nozzle, and the technique of an inkjet head in a well-known inkjet printer is applicable. For example, an element that discharges ink by causing film boiling in ink with an electrothermal transducer and forming a bubble, an element that discharges ink by an electromechanical transducer (piezoelectric element), an element that discharges ink by using static electricity, or the like can be given as the discharge element. A discharge element that uses the electrothermal transducer can be used from the viewpoint of high-speed and high-density printing.

In this embodiment, nine printheads 30 are provided. The respective printheads 30 discharge different kinds of inks. The different kinds of inks are, for example, different in coloring material and include yellow ink, magenta ink, cyan ink, black ink, and the like. One printhead 30 discharges one kind of ink. However, one printhead 30 may be configured to discharge the plurality of kinds of inks. When the plurality of printheads 30 are thus provided, some of them may discharge ink (for example, clear ink) that does not include a coloring material.

The carriage 31 supports the plurality of printheads 30. The end of each printhead 30 on the side of an ink discharge surface is fixed to the carriage 31. This makes it possible to maintain a gap on the surface between the ink discharge surface and the transfer member 2 more precisely. The carriage 31 is configured to be displaceable while mounting the printheads 30 by the guide of each guide unit RL. In this embodiment, the guide units RL are rail-like structures elongated in the Y direction and provided as a pair separately in the X direction. A slide portion 32 is provided on each side of the carriage 31 in the X direction. The slide portions 32 engage with the guide members RL and slide along the guide members RL in the Y direction.

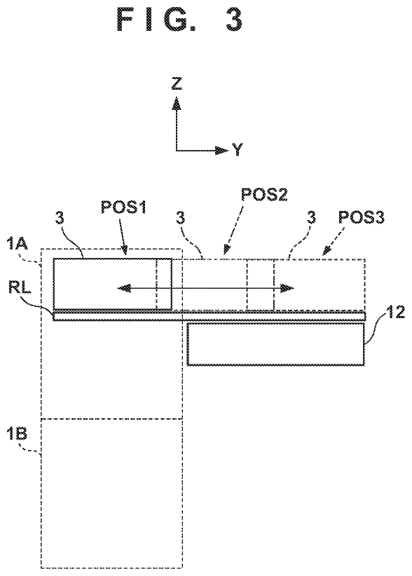

FIG. 3 is a view showing a displacement mode of the print unit 3 and schematically shows the right side surface of the printing system 1. A recovery unit 12 is provided in the rear of the printing system 1. The recovery unit 12 has a mechanism for recovering discharge performance of the printheads 30. For example, a cap mechanism which caps the ink discharge surface of each printhead 30, a wiper mechanism which wipes the ink discharge surface, a suction mechanism which sucks ink in the printhead 30 by a negative pressure from the ink discharge surface can be given as such mechanisms.

The guide unit RL is elongated over the recovery unit 12 from the side of the transfer member 2. By the guide of the guide unit RL, the print unit 3 is displaceable between a discharge position POS1 at which the print unit 3 is indicated by a solid line and a recovery position POS3 at which the print unit 3 is indicated by a broken line, and is moved by a driving mechanism (not shown).

The discharge position POS1 is a position at which the print unit 3 discharges ink to the transfer member 2 and a position at which the ink discharge surface of each printhead 30 faces the surface of the transfer member 2. The recovery position POS3 is a position retracted from the discharge position POS1 and a position at which the print unit 3 is positioned above the recovery unit 12. The recovery unit 12 can perform performance recovery processing on the printheads 30 when the print unit 3 is positioned at the recovery position POS3. In this embodiment, the recovery unit 12 can also perform the recovery processing in the middle of movement before the print unit 3 reaches the recovery position POS3. There is a preliminary recovery position POS2 between the discharge position POS1 and the recovery position POS3. The recovery unit 12 can perform preliminary recovery processing on the printheads 30 at the preliminary recovery position POS2 while the printheads 30 move from the discharge position POS1 to the recovery position POS3.

<Transfer Unit>

The transfer unit 4 will be described with reference to FIG. 1. The transfer unit 4 includes a transfer cylinder 41 and a pressurizing drum 42. Each of these drums is a rotating body that rotates about a rotation axis in the Y direction and has a columnar outer peripheral surface. In FIG. 1, arrows shown in respective views of the transfer cylinder 41 and the pressurizing drum 42 indicate their rotation directions. The transfer cylinder 41 rotates clockwise, and the pressurizing drum 42 rotates anticlockwise.

The transfer cylinder 41 is a support member that supports the transfer member 2 on its outer peripheral surface. The transfer member 2 is provided on the outer peripheral surface of the transfer cylinder 41 continuously or intermittently in a circumferential direction. If the transfer member 2 is provided continuously, it is formed into an endless swath. If the transfer member 2 is provided intermittently, it is formed into swaths with ends dividedly into a plurality of segments. The respective segments can be arranged in an arc at an equal pitch on the outer peripheral surface of the transfer cylinder 41.

The transfer member 2 moves cyclically on the circular orbit by rotating the transfer cylinder 41. By the rotational phase of the transfer cylinder 41, the position of the transfer member 2 can be discriminated into a processing area R1 before discharge, a discharge area R2, processing areas R3 and R4 after discharge, a transfer area R5, and a processing area R6 after transfer. The transfer member 2 passes through these areas cyclically.

The processing area R1 before discharge is an area where preprocessing is performed on the transfer member 2 before the print unit 3 discharges ink and an area where the peripheral unit 5A performs processing. In this embodiment, a reactive liquid is applied. The discharge area R2 is a formation area where the print unit 3 forms an ink image by discharging ink to the transfer member 2. The processing areas R3 and R4 after discharge are processing areas where processing is performed on the ink image after ink discharge. The processing area R3 after discharge is an area where the peripheral unit 5B performs processing, and the processing area R4 after discharge is an area where the peripheral unit 5C performs processing. The transfer area R5 is an area where the transfer unit 4 transfers the ink image on the transfer member 2 to the print medium P. The processing area R6 after transfer is an area where post processing is performed on the transfer member 2 after transfer and an area where the peripheral unit 5D performs processing.

In this embodiment, the discharge area R2 is an area with a predetermined section. The other areas R1 and R3 to R6 have narrower sections than the discharge area R2. Comparing to the face of a clock, in this embodiment, the processing area R1 before discharge is positioned at almost 10 o'clock, the discharge area R2 is in a range from almost 11 o'clock to 1 o'clock, the processing area R3 after discharge is positioned at almost 2 o'clock, and the processing area R4 after discharge is positioned at almost 4 o'clock. The transfer area R5 is positioned at almost 6 o'clock, and the processing area R6 after transfer is an area at almost 8 o'clock.

The transfer member 2 may be formed by a single layer but may be an accumulative body of a plurality of layers. If the transfer member 2 is formed by the plurality of layers, it may include three layers of, for example, a surface layer, an elastic layer, and a compressed layer. The surface layer is an outermost layer having an image formation surface where the ink image is formed. By providing the compressed layer, the compressed layer absorbs deformation and disperses a local pressure fluctuation, making it possible to maintain transferability even at the time of high-speed printing. The elastic layer is a layer between the surface layer and the compressed layer.

As a material for the surface layer, various materials such as a resin and a ceramic can be used appropriately. In respect of durability or the like, however, a material high in compressive modulus can be used. More specifically, an acrylic resin, an acrylic silicone resin, a fluoride-containing resin, a condensate obtained by condensing a hydrolyzable organosilicon compound, and the like can be given. The surface layer that has undergone a surface treatment may be used in order to improve wettability of the reactive liquid, the transferability of an image, or the like. Frame processing, a corona treatment, a plasma treatment, a polishing treatment, a roughing treatment, an active energy beam irradiation treatment, an ozone treatment, a surfactant treatment, a silane coupling treatment, or the like can be given as the surface treatment. A plurality of them may be combined. It is also possible to provide any desired surface shape in the surface layer.

For example, acrylonitrile-butadiene rubber, acrylic rubber, chloroprene rubber, urethane rubber, silicone rubber, or the like can be given as a material for the compressed layer. When such a rubber material is formed, a porous rubber material may be formed by blending a predetermined amount of a vulcanizing agent, vulcanizing accelerator, or the like and further blending a foaming agent, or a filling agent such as hollow fine particles or salt as needed. Consequently, a bubble portion is compressed along with a volume change with respect to various pressure fluctuations, and thus deformation in directions other than a compression direction is small, making it possible to obtain more stable transferability and durability. As the porous rubber material, there are a material having an open cell structure in which respective pores continue to each other and a material having a closed cell structure in which the respective pores are independent of each other. However, either structure may be used, or both of these structures may be used.

As a member for the elastic layer, the various materials such as the resin and the ceramic can be used appropriately. In respect of processing characteristics, various materials of an elastomer material and a rubber material can be used. More specifically, for example, fluorosilicone rubber, phenyl silicone rubber, fluorine rubber, chloroprene rubber, urethane rubber, nitrile rubber, and the like can be given. In addition, ethylene propylene rubber, natural rubber, styrene rubber, isoprene rubber, butadiene rubber, the copolymer of ethylene/propylene/butadiene, nitrile-butadiene rubber, and the like can be given. In particular, silicone rubber, fluorosilicone rubber, and phenyl silicon rubber are advantageous in terms of dimensional stability and durability because of their small compression set. They are also advantageous in terms of transferability because of their small elasticity change by a temperature.

Between the surface layer and the elastic layer and between the elastic layer and the compressed layer, various adhesives or double-sided adhesive tapes can also be used in order to fix them to each other. The transfer member 2 may also include a reinforce layer high in compressive modulus in order to suppress elongation in a horizontal direction or maintain resilience when attached to the transfer cylinder 41. Woven fabric may be used as a reinforce layer. The transfer member 2 can be manufactured by combining the respective layers formed by the materials described above in any desired manner.

The outer peripheral surface of the pressurizing drum 42 is pressed against the transfer member 2. At least one grip mechanism which grips the leading edge portion of the print medium P is provided on the outer peripheral surface of the pressurizing drum 42. A plurality of grip mechanisms may be provided separately in the circumferential direction of the pressurizing drum 42. The ink image on the transfer member 2 is transferred to the print medium P when it passes through a nip portion between the pressurizing drum 42 and the transfer member 2 while being conveyed in tight contact with the outer peripheral surface of the pressurizing drum 42.

The transfer cylinder 41 and the pressurizing drum 42 can share a driving source such as a motor that drives them, and a driving force can be delivered by a transmission mechanism such as a gear mechanism.

<Peripheral Unit>

The peripheral units 5A to 5D are arranged around the transfer cylinder 41. In this embodiment, the peripheral units 5A to 5D are specifically an application unit, an absorption unit, a heating unit, and a cleaning unit in order.

The application unit 5A is a mechanism which applies the reactive liquid onto the transfer member 2 before the print unit 3 discharges ink. The reactive liquid is a liquid that contains a component increasing an ink viscosity. An increase in ink viscosity here means that a coloring material, a resin, and the like that form the ink react chemically or suck physically by contacting the component that increases the ink viscosity, recognizing the increase in ink viscosity. This increase in ink viscosity includes not only a case in which an increase in viscosity of entire ink is recognized but also a case in which a local increase in viscosity is generated by coagulating some of components such as the coloring material and the resin that form the ink.

The component that increases the ink viscosity can use, without particular limitation, a substance such as metal ions or a polymeric coagulant that causes a pH change in ink and coagulates the coloring material in the ink, and can use an organic acid. For example, a roller, a printhead, a die coating apparatus (die coater), a blade coating apparatus (blade coater), or the like can be given as a mechanism which applies the reactive liquid. If the reactive liquid is applied to the transfer member 2 before the ink is discharged to the transfer member 2, it is possible to immediately fix ink that reaches the transfer member 2. This makes it possible to suppress bleeding caused by mixing adjacent inks.

The absorption unit 5B is a mechanism which absorbs a liquid component from the ink image on the transfer member 2 before transfer. It is possible to suppress, for example, a blur of an image printed on the print medium P by decreasing the liquid component of the ink image. Describing a decrease in liquid component from another point of view, it is also possible to represent it as condensing ink that forms the ink image on the transfer member 2. Condensing the ink means increasing the content of a solid content such as a coloring material or a resin included in the ink with respect to the liquid component by decreasing the liquid component included in the ink.

The absorption unit 5B includes, for example, a liquid absorbing member that decreases the amount of the liquid component of the ink image by contacting the ink image. The liquid absorbing member may be formed on the outer peripheral surface of the roller or may be formed into an endless sheet-like shape and run cyclically. In terms of protection of the ink image, the liquid absorbing member may be moved in synchronism with the transfer member 2 by making the moving speed of the liquid absorbing member equal to the peripheral speed of the transfer member 2.

The liquid absorbing member may include a porous body that contacts the ink image. The pore size of the porous body on the surface that contacts the ink image may be equal to or smaller than 10 μm in order to suppress adherence of an ink solid content to the liquid absorbing member. The pore size here refers to an average diameter and can be measured by a known means such as a mercury intrusion technique, a nitrogen adsorption method, an SEM image observation, or the like. Note that the liquid component does not have a fixed shape, and is not particularly limited if it has fluidity and an almost constant volume. For example, water, an organic solvent, or the like contained in the ink or reactive liquid can be given as the liquid component.

The heating unit 5C is a mechanism which heats the ink image on the transfer member 2 before transfer. A resin in the ink image melts by heating the ink image, improving transferability to the print medium P. A heating temperature can be equal to or higher than the minimum film forming temperature (MFT) of the resin. The MFT can be measured by each apparatus that complies with a generally known method such as JIS K 6828-2: 2003 or ISO 2115: 1996. From the viewpoint of transferability and image robustness, the ink image may be heated at a temperature higher than the MFT by 10° C. or higher, or may further be heated at a temperature higher than the MFT by 20° C. or higher. The heating unit 5C can use a known heating device, for example, various lamps such as infrared rays, a warm air fan, or the like. An infrared heater can be used in terms of heating efficiency.

The cleaning unit 5D is a mechanism which cleans the transfer member 2 after transfer. The cleaning unit 5D removes ink remaining on the transfer member 2, dust on the transfer member 2, or the like. The cleaning unit 5D can use a known method, for example, a method of bringing a porous member into contact with the transfer member 2, a method of scraping the surface of the transfer member 2 with a brush, a method of scratching the surface of the transfer member 2 with a blade, or the like as needed. A known shape such as a roller shape or a web shape can be used for a cleaning member used for cleaning.

As described above, in this embodiment, the application unit 5A, the absorption unit 5B, the heating unit 5C, and the cleaning unit 5D are included as the peripheral units. However, cooling functions of the transfer member 2 may be applied, or cooling units may be added to these units. In this embodiment, the temperature of the transfer member 2 may be increased by heat of the heating unit 5C. If the ink image exceeds the boiling point of water as a prime solvent of ink after the print unit 3 discharges ink to the transfer member 2, performance of liquid component absorption by the absorption unit 5B may be degraded. It is possible to maintain the performance of liquid component absorption by cooling the transfer member 2 such that the temperature of the discharged ink is maintained below the boiling point of water.

The cooling unit may be an air blowing mechanism which blows air to the transfer member 2, or a mechanism which brings a member (for example, a roller) into contact with the transfer member 2 and cools this member by air-cooling or water-cooling. The cooling unit may be a mechanism which cools the cleaning member of the cleaning unit 5D. A cooling timing may be a period before application of the reactive liquid after transfer.

<Supply Unit>

The supply unit 6 is a mechanism which supplies ink to each printhead 30 of the print unit 3. The supply unit 6 may be provided on the rear side of the printing system 1. The supply unit 6 includes a reservoir TK that reserves ink for each kind of ink. Each reservoir TK may be made of a main tank and a sub tank. Each reservoir TK and a corresponding one of the printheads 30 communicate with each other by a liquid passageway 6a, and ink is supplied from the reservoir TK to the printhead 30. The liquid passageway 6a may circulate ink between the reservoirs TK and the printheads 30. The supply unit 6 may include, for example, a pump that circulates ink. A deaerating mechanism which deaerates bubbles in ink may be provided in the middle of the liquid passageway 6a or in each reservoir TK. A valve that adjusts the fluid pressure of ink and an atmospheric pressure may be provided in the middle of the liquid passageway 6a or in each reservoir TK. The heights of each reservoir TK and each printhead 30 in the Z direction may be designed such that the liquid surface of ink in the reservoir TK is positioned lower than the ink discharge surface of the printhead 30.

<Conveyance Apparatus>

The conveyance apparatus 1B is an apparatus that feeds the print medium P to the transfer unit 4 and discharges, from the transfer unit 4, the printed product P′ to which the ink image was transferred. The conveyance apparatus 1B includes a feeding unit 7, a plurality of conveyance drums 8 and 8a, two sprockets 8b, a chain 8c, and a collection unit 8d. In FIG. 1, an arrow inside a view of each constituent element in the conveyance apparatus 1B indicates a rotation direction of the constituent element, and an arrow outside the view of each constituent element indicates a conveyance path of the print medium P or the printed product P′. The print medium P is conveyed from the feeding unit 7 to the transfer unit 4, and the printed product P′ is conveyed from the transfer unit 4 to the collection unit 8d. The side of the feeding unit 7 may be referred to as an upstream side in a conveyance direction, and the side of the collection unit 8d may be referred to as a downstream side.

The feeding unit 7 includes a stacking unit where the plurality of print media P are stacked and a feeding mechanism which feeds the print media P one by one from the stacking unit to the most upstream conveyance drum 8. Each of the conveyance drums 8 and 8a is a rotating body that rotates about the rotation axis in the Y direction and has a columnar outer peripheral surface. At least one grip mechanism which grips the leading edge portion of the print medium P (printed product P′) is provided on the outer peripheral surface of each of the conveyance drums 8 and 8a. A gripping operation and release operation of each grip mechanism may be controlled such that the print medium P is transferred between the adjacent conveyance drums.

The two conveyance drums 8a are used to reverse the print medium P. When the print medium P undergoes double-side printing, it is not transferred to the conveyance drum 8 adjacent on the downstream side but transferred to the conveyance drums 8a from the pressurizing drum 42 after transfer onto the surface. The print medium P is reversed via the two conveyance drums 8a and transferred to the pressurizing drum 42 again via the conveyance drums 8 on the upstream side of the pressurizing drum 42. Consequently, the reverse surface of the print medium P faces the transfer cylinder 41, transferring the ink image to the reverse surface.

The chain 8c is wound between the two sprockets 8b. One of the two sprockets 8b is a driving sprocket, and the other is a driven sprocket. The chain 8c runs cyclically by rotating the driving sprocket. The chain 8c includes a plurality of grip mechanisms spaced apart from each other in its longitudinal direction. Each grip mechanism grips the end of the printed product P′. The printed product P′ is transferred from the conveyance drum 8 positioned at a downstream end to each grip mechanism of the chain 8c, and the printed product P′ gripped by the grip mechanism is conveyed to the collection unit 8d by running the chain 8c, releasing gripping. Consequently, the printed product P′ is stacked in the collection unit 8d.

<Post Processing Unit>

The conveyance apparatus 1B includes post processing units 10A and 10B. The post processing units 10A and 10B are mechanisms which are arranged on the downstream side of the transfer unit 4, and perform post processing on the printed product P′. The post processing unit 10A performs processing on the obverse surface of the printed product P′, and the post processing unit 10B performs processing on the reverse surface of the printed product P′. The contents of the post processing includes, for example, coating that aims at protection, glossy, and the like of an image on the image printed surface of the printed product P′. For example, liquid application, sheet welding, lamination, and the like can be given as an example of coating.

<Inspection Unit>

The conveyance apparatus 1B includes inspection units 9A and 9B. The inspection units 9A and 9B are mechanisms which are arranged on the downstream side of the transfer unit 4, and inspect the printed product P′.

In this embodiment, the inspection unit 9A is an image capturing apparatus that captures an image printed on the printed product P′ and includes an image sensor, for example, a CCD sensor, a CMOS sensor, or the like. The inspection unit 9A captures a printed image while a printing operation is performed continuously. Based on the image captured by the inspection unit 9A, it is possible to confirm a temporal change in tint or the like of the printed image and determine whether to correct image data or print data. In this embodiment, the inspection unit 9A has an imaging range set on the outer peripheral surface of the pressurizing drum 42 and is arranged to be able to partially capture the printed image immediately after transfer. The inspection unit 9A may inspect all printed images or may inspect the images every predetermined sheets.

In this embodiment, the inspection unit 9B is also an image capturing apparatus that captures an image printed on the printed product P′ and includes an image sensor, for example, a CCD sensor, a CMOS sensor, or the like. The inspection unit 9B captures a printed image in a test printing operation. The inspection unit 9B can capture the entire printed image. Based on the image captured by the inspection unit 9B, it is possible to perform basic settings for various correction operations regarding print data. In this embodiment, the inspection unit 9B is arranged at a position to capture the printed product P′ conveyed by the chain 8c. When the inspection unit 9B captures the printed image, it captures the entire image by temporarily suspending the run of the chain 8c. The inspection unit 9B may be a scanner that scans the printed product P′.

<Control Unit>

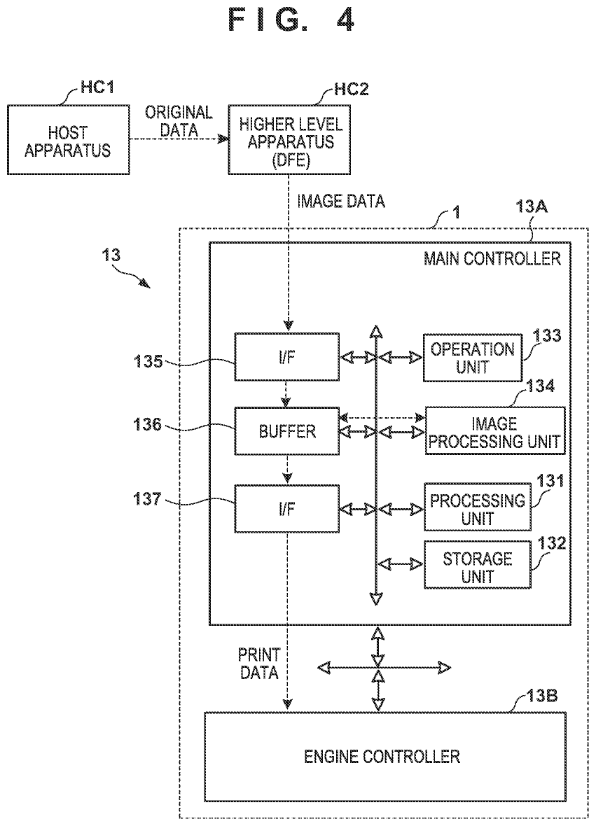

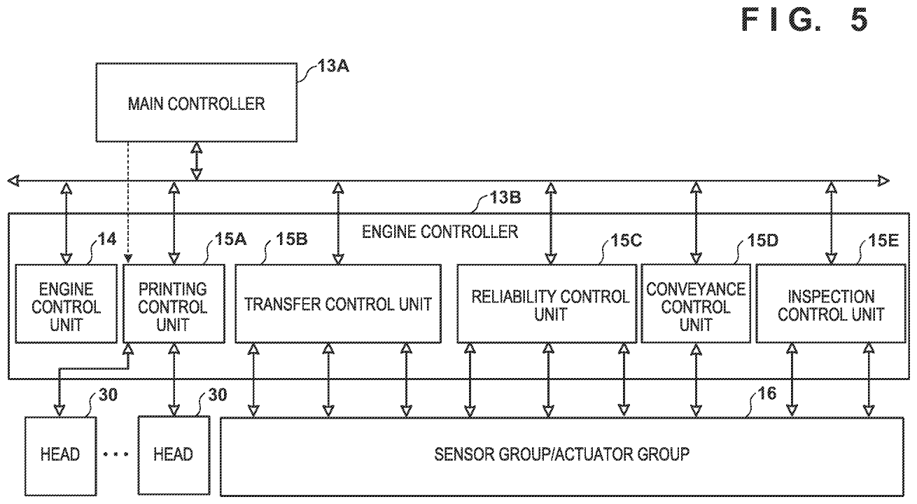

A control unit of the printing system 1 will be described next. FIGS. 4 and 5 are block diagrams each showing a control unit 13 of the printing system 1. The control unit 13 is communicably connected to a higher level apparatus (DFE) HC2, and the higher level apparatus HC2 is communicably connected to a host apparatus HC1.

Original data to be the source of a printed image is generated or saved in the host apparatus HC1. The original data here is generated in the format of, for example, an electronic file such as a document file or an image file. This original data is transmitted to the higher level apparatus HC2. In the higher level apparatus HC2, the received original data is converted into a data format (for example, RGB data that represents an image by RGB) available by the control unit 13. The converted data is transmitted from the higher level apparatus HC2 to the control unit 13 as image data. The control unit 13 starts a printing operation based on the received image data.

In this embodiment, the control unit 13 is roughly divided into a main controller 13A and an engine controller 13B. The main controller 13A includes a processing unit 131, a storage unit 132, an operation unit 133, an image processing unit 134, a communication I/F (interface) 135, a buffer 136, and a communication I/F 137.

The processing unit 131 is a processor such as a CPU, executes programs stored in the storage unit 132, and controls the entire main controller 13A. The storage unit 132 is a storage device such as a RAM, a ROM, a hard disk, or an SSD, stores data and the programs executed by the processing unit (CPU) 131, and provides the processing unit (CPU) 131 with a work area. The operation unit 133 is, for example, an input device such as a touch panel, a keyboard, or a mouse and accepts a user instruction.

The image processing unit 134 is, for example, an electronic circuit including an image processing processor. The buffer 136 is, for example, a RAM, a hard disk, or an SSD. The communication I/F 135 communicates with the higher level apparatus HC2, and the communication I/F 137 communicates with the engine controller 13B. In FIG. 4, broken-line arrows exemplify the processing sequence of image data. Image data received from the higher level apparatus HC2 via the communication I/F 135 is accumulated in the buffer 136. The image processing unit 134 reads out the image data from the buffer 136, performs predetermined image processing on the readout image data, and stores the processed data in the buffer 136 again. The image data after the image processing stored in the buffer 136 is transmitted from the communication I/F 137 to the engine controller 13B as print data used by a print engine.

As shown in FIG. 5, the engine controller 13B includes control units 14 and 15A to 15E, and obtains a detection result of a sensor group/actuator group 16 of the printing system 1 and controls driving of the groups. Each of these control units includes a processor such as a CPU, a storage device such as a RAM or a ROM, and an interface with an external device. Note that the division of the control units is merely illustrative, and a plurality of subdivided control units may perform some of control operations or conversely, the plurality of control units may be integrated with each other, and one control unit may be configured to implement their control contents.

The engine control unit 14 controls the entire engine controller 13B. The printing control unit 15A converts print data received from the main controller 13A into raster data or the like in a data format suitable for driving of the printheads 30. The printing control unit 15A controls discharge of each printhead 30.

The transfer control unit 15B controls the application unit 5A, the absorption unit 5B, the heating unit 5C, and the cleaning unit 5D.

The reliability control unit 15C controls the supply unit 6, the recovery unit 12, and a driving mechanism which moves the print unit 3 between the discharge position POS1 and the recovery position POS3.

The conveyance control unit 15D controls driving of the transfer unit 4 and controls the conveyance apparatus 1B. The inspection control unit 15E controls the inspection unit 9B and the inspection unit 9A.

Of the sensor group/actuator group 16, the sensor group includes a sensor that detects the position and speed of a movable part, a sensor that detects a temperature, an image sensor, and the like. The actuator group includes a motor, an electromagnetic solenoid, an electromagnetic valve, and the like.

<Operation Example>

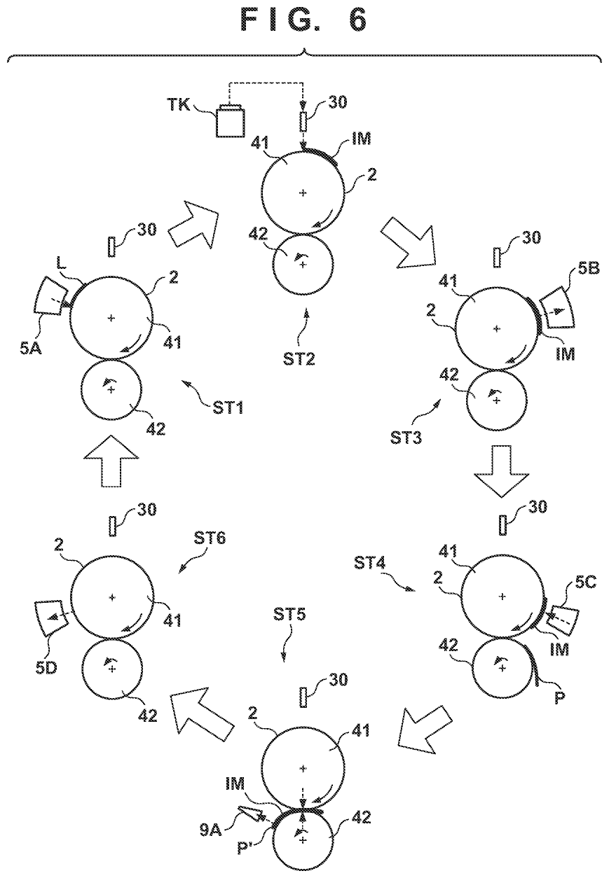

FIG. 6 is a view schematically showing an example of a printing operation. Respective steps below are performed cyclically while rotating the transfer cylinder 41 and the pressurizing drum 42. As shown in a state ST1, first, a reactive liquid L is applied from the application unit 5A onto the transfer member 2. A portion to which the reactive liquid L on the transfer member 2 is applied moves along with the rotation of the transfer cylinder 41. When the portion to which the reactive liquid L is applied reaches under the printhead 30, ink is discharged from the printhead 30 to the transfer member 2 as shown in a state ST2. Consequently, an ink image IM is formed. At this time, the discharged ink mixes with the reactive liquid L on the transfer member 2, promoting coagulation of the coloring materials. The discharged ink is supplied from the reservoir TK of the supply unit 6 to the printhead 30.

The ink image IM on the transfer member 2 moves along with the rotation of the transfer member 2. When the ink image IM reaches the absorption unit 5B, as shown in a state ST3, the absorption unit 5B absorbs a liquid component from the ink image IM. When the ink image IM reaches the heating unit 5C, as shown in a state ST4, the heating unit 5C heats the ink image IM, a resin in the ink image IM melts, and a film of the ink image IM is formed. In synchronism with such formation of the ink image IM, the conveyance apparatus 1B conveys the print medium P.

As shown in a state ST5, the ink image IM and the print medium P reach the nip portion between the transfer member 2 and the pressurizing drum 42, the ink image IM is transferred to the print medium P, and the printed product P′ is formed. Passing through the nip portion, the inspection unit 9A captures an image printed on the printed product P′ and inspects the printed image. The conveyance apparatus 1B conveys the printed product P′ to the collection unit 8d.

When a portion where the ink image IM on the transfer member 2 is formed reaches the cleaning unit 5D, it is cleaned by the cleaning unit 5D as shown in a state ST6. After the cleaning, the transfer member 2 rotates once, and transfer of the ink image to the print medium P is performed repeatedly in the same procedure. The description above has been given such that transfer of the ink image IM to one print medium P is performed once in one rotation of the transfer member 2 for the sake of easy understanding. It is possible, however, to continuously perform transfer of the ink image IM to the plurality of print media P in one rotation of the transfer member 2.

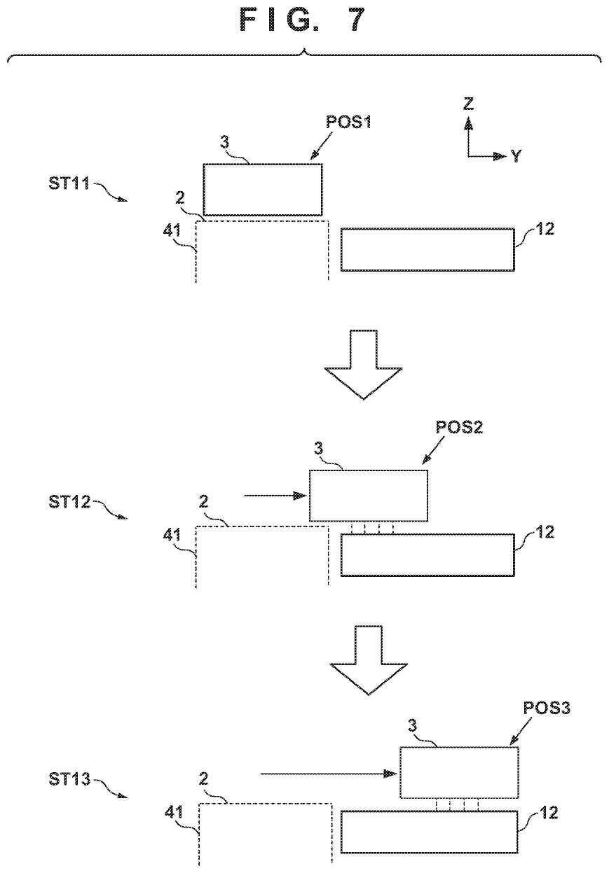

Each printhead 30 needs maintenance if such a printing operation continues. FIG. 7 shows an operation example at the time of maintenance of each printhead 30. A state ST11 shows a state in which the print unit 3 is positioned at the discharge position POS1. A state ST12 shows a state in which the print unit 3 passes through the preliminary recovery position POS2. Under passage, the recovery unit 12 performs a process of recovering discharge performance of each printhead 30 of the print unit 3. Subsequently, as shown in a state ST13, the recovery unit 12 performs the process of recovering the discharge performance of each printhead 30 in a state in which the print unit 3 is positioned at the recovery position POS3.

<Absorbing unit>

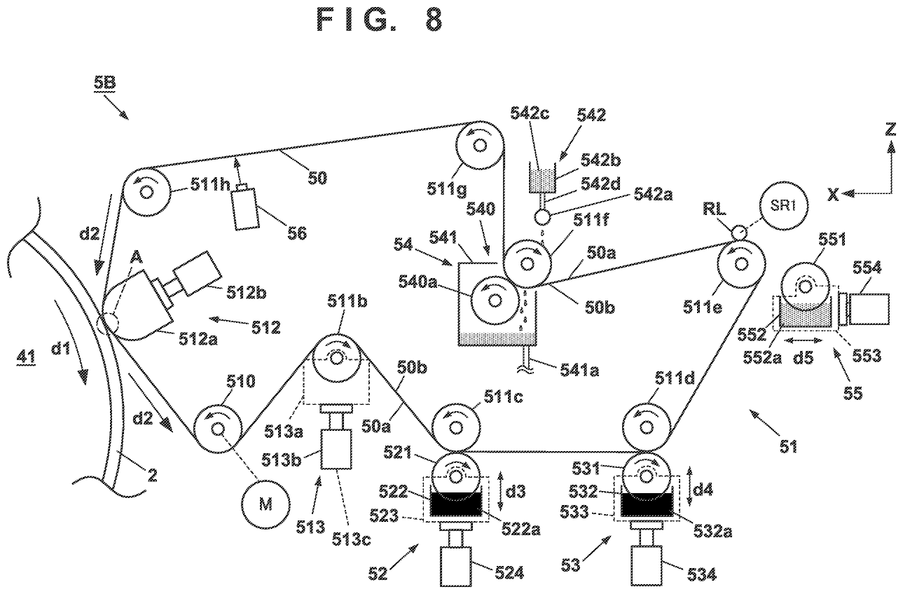

A detailed example of the absorbing unit 5B will be described with reference to FIG. 8. FIG. 8 is a schematic view showing an example of the absorbing unit 5B. The absorbing unit 5B is a liquid absorbing apparatus that absorbs a liquid component from an ink image formed on an ink receiving medium. In this embodiment, the absorbing unit 5B absorbs a liquid component from the ink image IM formed on the transfer member 2 before the ink image IM is transferred to the print medium P. When the water-soluble pigment ink is used as in this embodiment, the absorbing unit 5B mainly aims at absorbing moisture in the ink image. This makes it possible to suppress occurrence of a curl or cockling of the print medium P.

The absorbing unit 5B includes a liquid absorbing member 50, a driving unit 51 that cyclically moves the liquid absorbing member 50, a displacing unit 512, a plurality of kinds of recovery units 52 to 54, a preprocessing unit 55, and a detection unit 56.

The liquid absorbing member 50 is an absorber that absorbs the liquid component from the ink image IM and is a liquid absorbing sheet formed into an endless belt in the example of FIG. 8. A liquid absorbing position A is a position where the liquid absorbing member 50 absorbs the liquid component from the ink image IM on the transfer member 2 and indicates a portion where the liquid absorbing member 50 gets closest to the transfer member 2. An arrow dl indicates a moving direction of the transfer member 2, and an arrow d2 indicates a moving direction of the liquid absorbing member 50.

The liquid absorbing member 50 may be formed by a single layer but may be formed by multiple layers. A double layer structure of an obverse layer and a reverse layer is exemplified here. The obverse layer forms a first surface 50a contacting the ink image IM, and the reverse layer forms a second surface 50b opposite to the first surface 50a. The liquid absorbing member 50 absorbs the liquid component of the ink image IM on the transfer member 2. The liquid component of the ink image IM penetrates from the obverse layer into the liquid absorbing member 50 and further penetrates into the reverse layer. The ink image IM moves toward the heating unit 5C with a decreased liquid component.

Each of the obverse layer and the reverse layer can be made of a porous material. The average pore size of the reverse layer can be made larger than that of the obverse layer in order to increase absorption performance of the liquid component while suppressing adherence of the coloring material. This makes it possible to promote movement of the liquid component from the obverse layer to the reverse layer.

A material for the obverse layer may be, for example, a hydrophilic material whose contact angle with respect to water is less than 90° or a water-repellent material whose contact angle with respect to water is 90° or more. For the hydrophilic material, the material may have the contact angle with respect to water to be 40° or less. The contact angle may be measured complying with a technique described in, for example, “6. static method” of ES R3257.

The hydrophilic material has an effect of drawing up a liquid by a capillary force. Cellulose, polyacrylamide, or a composite material of these can be given as the hydrophilic material. When the water-repellent material is used, a hydrophilic treatment may be performed on its surface. A method such as sputter etching can be given as the hydrophilic treatment.

For example, a fluorine resin can be given as the water-repellent material. For example, polytetrafluoroethylene, polychlorotrifluoroethylene, polyvinylidene fluoride, or the like can be given as the fluorine resin. A time may be taken until the effect of drawing up the liquid is exerted when the water-repellent material is used for the obverse layer. To cope with this, a liquid whose contact angle with the obverse layer is less than 90° may be impregnated into the obverse layer.

For example, resin-fiber nonwoven fabric or woven fabric can be given as a material for the reverse layer. The material for the reverse layer may have the contact angle of water equal to or larger than that for the obverse layer because the liquid component does not flow backward from the reverse layer to the obverse layer. For example, polyolefin, polyurethane, polyamide such as nylon, polyester, polysulfone, or a composite material of these can be given as the material for the reverse layer.

For example, adhesive lamination, thermal lamination, or the like can be given as a laminating method of the obverse layer and the reverse layer.

The driving unit 51 is a mechanism which supports the liquid absorbing member 50 such that it can rotate and move cyclically so as to pass through the liquid absorbing position A, and includes a drive rotating body 510 and a plurality of driven rotating bodies 511b to 511h. The drive rotating body 510 and the driven rotating bodies 511 are rollers or pulleys around which the swath liquid absorbing member 50 is wound and are supported rotatably about an axis in the Y direction.

The drive rotating body 510 is a conveyance rotating body such as a conveyance roller that rotates by a driving force of a motor M, and rotates and moves the liquid absorbing member 50. The driven rotating bodies 511b to 511h are supported freely rotatably. In this embodiment, these drive rotating body 510 and driven rotating bodies 511b to 511h define a rotating and moving path of the liquid absorbing member 50. The rotating and moving path of the liquid absorbing member 50 is a zigzag path winding up and down when viewed from a rotating and moving direction (arrow d2). This makes it possible to use the longer liquid absorbing member 50 in a smaller space and decrease a replacement frequency upon performance deterioration in the liquid absorbing member 50.

The driven rotating body 511b includes a tension adjustment mechanism 513. The tension adjustment mechanism 513 is a mechanism which adjusts the tension of the liquid absorbing member 50 and includes a support member 513a, a moving mechanism 513b, and a sensor 513c. The support member 513a supports the driven rotating body 511b rotatably about the axis in the Y direction. The moving mechanism 513b is a mechanism which moves the support member 513a and is, for example, an electrically-driven cylinder. The moving mechanism 513b can displace the position of the driven rotating body 511b, adjusting the tension of the liquid absorbing member 50. The sensor 513c detects the tension of the liquid absorbing member 50. In this embodiment, the sensor 513c detects a load received by the moving mechanism 513b. The tension of the liquid absorbing member 50 can be controlled automatically by controlling the moving mechanism 513b based on a detection result of the sensor 513c.

The displacing unit 512 is a mechanism which displaces the liquid absorbing member 50 between a contact state in which the liquid absorbing member 50 contacts the transfer member 2 and a retracted state in which the liquid absorbing member 50 is separated from the transfer member 2. In this embodiment, the displacing unit 512 acts on a part of the liquid absorbing member 50, and displaces the liquid absorbing member 50 between a state in which the part contacts the transfer member and a state in which the part is separated from the transfer member. However, the displacing unit 512 may move the liquid absorbing member 50 as a unit.

The displacing unit 512 includes a movable member 512a and a pressing unit 512b. The movable member 512a is arranged facing the transfer member 2 and has a peripheral surface where the liquid absorbing member 50 slidably moves. The pressing unit 512b is a unit which moves the movable member 512a forward/backward with respect to the transfer member 2, and is, for example, an electrically-driven cylinder. The part of the liquid absorbing member is pressed against the transfer member 2 via the movable member 512a by driving the pressing unit 512b.

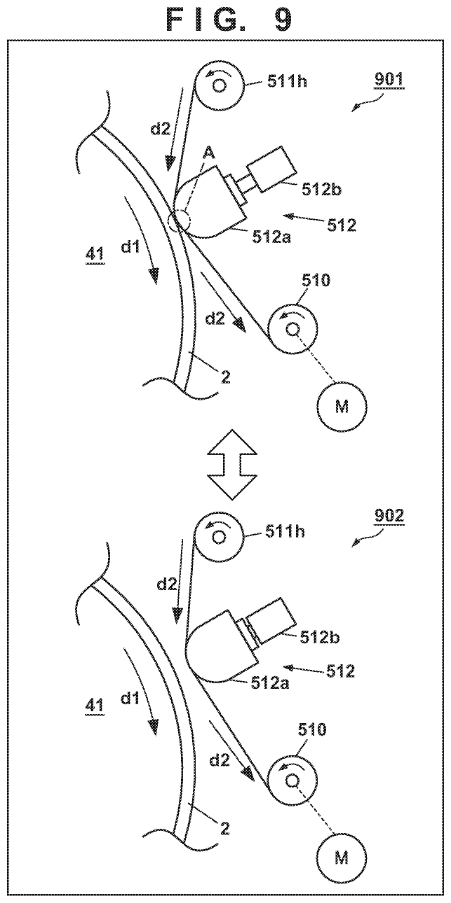

FIG. 9 shows explanatory views showing the operation of the displacing unit 512. A state 901 shows a state in which the liquid absorbing member 50 is displaced to the contact state. A state 902 shows a state in which the liquid absorbing member 50 is displaced to the retracted state.

When the liquid absorbing member 50 is displaced to the contact state, the liquid absorbing member 50 and the transfer member 2 contact each other at the liquid absorbing position A. At the liquid absorbing position A, the liquid absorbing member 50 is nipped by the transfer member 2 and the movable member 512a. The liquid absorbing member 50 is advantageously pressed against the transfer member 2 in terms of liquid absorption efficiency. During a printing operation, the driving unit 51 controls the liquid absorbing member 50 so that a rotating and moving velocity of the liquid absorbing member 50 becomes equal to a peripheral velocity of the transfer member 2. This prevents friction between the liquid absorbing member 50 and the transfer member 2 or the ink image IM.

The retracted state can be at a position where the liquid absorbing member 50 can be separated from the transfer member 2, and a distance between the contact state and the retracted state can be short. A direction in which the part of the liquid absorbing member 50 moves between the contact state and the retracted state, that is, the pressing/releasing direction of the pressing unit 512b is a direction crossing the tangential direction of the transfer member 2 at the liquid absorbing position A and is, for example, a perpendicular direction.

The liquid absorbing member 50 is arranged to contact or separate from the transfer member 2 freely by providing the displacing unit 512, making it easier to perform a maintenance operation or warm-up of the transfer member 2 and liquid absorbing member 50 individually.

Referring back to FIG. 8, a sensor SR1 detects a rotating and moving velocity or rotating and moving amount of the liquid absorbing member 50. The sensor SR1 is, for example, a rotary encoder. In this embodiment, a rotating body RL of the sensor SR1 contacts the liquid absorbing member 50, rotates in accordance with rotation and movement of the liquid absorbing member 50, and detects its rotation amount. The rotating body RL is arranged facing the driven rotating body 511e. The rotating and moving velocity or rotating and moving amount of the liquid absorbing member 50 can also be specified by detecting and calculating the rotation velocity of the drive rotating body 510 or those of the driven rotating bodies 511b to 511h. However, the liquid absorbing member 50 may slip with respect to these rotating bodies, and thus a value different from an actual moving velocity of the liquid absorbing member 50 may be obtained.

The recovery units 52 to 54 are apparatuses that recover the liquid absorption performance of the liquid absorbing member 50. By providing such recovery mechanisms, it is possible to suppress the performance deterioration in the liquid absorbing member 50 and maintain the liquid absorption performance for a longer time. This makes it possible to decrease the replacement frequency of the liquid absorbing member 50. In addition, in this embodiment, the recovery units 52 to 54 are arranged in the order of, starting from the liquid absorbing position A, the liquid absorbing position A, the recovery unit 52, the recovery unit 53, the recovery unit 54, and the liquid absorbing position A as seen in the moving direction of the liquid absorbing member 50 that moves cyclically. That is, the recovery unit 53 is arranged upstream of the recovery unit 54, and the recovery unit 52 is arranged upstream of the recovery unit 53. In this embodiment, the three kinds of recovery units 52 to 54 different in function are arranged in the middle of the moving path of the liquid absorbing member 50. However, only one recovery unit may be provided. Alternatively, a plurality of recovery units having a common function may be provided.

The recovery unit 52 and the recovery unit 53 perform processes on the first surface 50a, and the recovery unit 54 performs a process on the second surface 50b. By performing the different processes for the first surface 50a and the second surface 50b, it is possible to recover the liquid absorption performance of the liquid absorbing member 50 more properly.

The recovery unit 52 is an apparatus that cleans the liquid absorbing member 50. The recovery unit 52 includes a cleaning roller 521, a reservoir 522, a support member 523, and a moving mechanism 524. The support member 523 supports the cleaning roller 521 rotatably about the axis in the Y direction and also supports the reservoir 522. A cleaning liquid 522a is reserved in the reservoir 522. The cleaning roller 521 is partially immersed in the cleaning liquid 522a. The moving mechanism 524 is a mechanism which moves the support member 523 and is, for example, an electrically-driven cylinder. The cleaning roller 521 and the reservoir 522 also move when the support member 523 moves. They move in the direction of an arrow d3 (here, the vertical direction) between a cleaning position at which the cleaning roller 521 contacts the liquid absorbing member 50 and a retracted position at which the cleaning roller 521 is separated from the liquid absorbing member 50. FIG. 8 shows a state in which the cleaning roller 521 is located at the cleaning position (a state during a recovery operation). The cleaning roller 521 may be located at the cleaning position during the operation of the printing system 1 and may move to the retracted position at the time of maintenance.

The cleaning roller 521 is arranged facing the driven rotating body 511c, and configured such that the liquid absorbing member 50 is nipped by the cleaning roller 521 and the driven rotating body 511c when the cleaning roller 521 moves to the cleaning position. The cleaning roller 521 rotates in accordance with rotation and movement of the liquid absorbing member 50. The peripheral surface of the cleaning roller 521 is formed by, for example, a cohesive material and removes a dust particle (paper dust or the like) adhered to the first surface 50a of the liquid absorbing member 50 by contacting the first surface 50a. For example, rubber of butyl, silicone, urethane, or the like can be given as a material for the peripheral surface of the cleaning roller 521. The cleaning liquid 522a is, for example, a surfactant and can use a liquid that promotes separation of a dust particle adhered to the cleaning roller 521. The reservoir 522 may include a wiper that promotes separation of dust particles by contacting the surface of the cleaning roller 521. Furthermore, a roller that is higher in adhesiveness than the cleaning roller 521 and takes out the dust particles from the cleaning roller 521 may be arranged in the reservoir 522.

In this embodiment, an arrangement that removes the dust particle adhered to the first surface 50a of the liquid absorbing member 50 by the cleaning roller 521 is adopted. However, another arrangement such as an arrangement that removes dust particles by blowing air may also be adopted.

The recovery unit 53 is an apparatus that applies a liquid to the liquid absorbing member 50. The recovery unit 53 includes an application roller 531, a reservoir 532, a support member 533, and a moving mechanism 534. The support member 533 supports the application roller 531 rotatably about the axis in the Y direction and also supports the reservoir 532. A moisturizing liquid 532a is reserved in the reservoir 532. The application roller 531 is partially immersed in the moisturizing liquid 532a. The moving mechanism 534 is a mechanism which moves the support member 533 and is, for example, an electrically-driven cylinder. The application roller 531 and the reservoir 532 also move when the support member 533 moves. They move in the direction of an arrow d4 (here, the vertical direction) between an application position at which the application roller 531 contacts the liquid absorbing member 50 and a retracted position at which the application roller 531 is separated from the liquid absorbing member 50. FIG. 8 shows a state in which the application roller 531 is located at the application position (a state during the recovery operation). The application roller 531 may be located at the application position during the operation of the printing system 1 and may move to the retracted position at the time of maintenance.

The application roller 531 is arranged facing the driven rotating body 511d, and configured such that the liquid absorbing member 50 is nipped by the application roller 531 and the driven rotating body 511d when the application roller 531 moves to the application position. The application roller 531 rotates in accordance with rotation and movement of the liquid absorbing member 50. The peripheral surface of the application roller 531 is formed by, for example, rubber and supplies the moisturizing liquid 532a reserved in the reservoir 532 to the first surface 50a of the liquid absorbing member 50 by drawing the moisturizing liquid 532a. The moisturizing liquid 532a is, for example, water. The moisturizing liquid 532a may contain a water-soluble organic solvent or a surfactant.

The first surface 50a may be thickened by using the liquid absorbing member 50, and this may degrade absorption performance of the liquid component from the ink image IM. It is possible to suppress thickening of the first surface 50a and maintain the absorption performance of the liquid component by applying the moisturizing liquid 532a to the first surface 50a.

In this embodiment, an arrangement that draws the moisturizing liquid 532a to the first surface 50a of the liquid absorbing member 50 by the application roller 531 is adopted. However, another arrangement such as an arrangement that sprays the moisturizing liquid 532a to the first surface 50a by a nozzle may also be adopted.

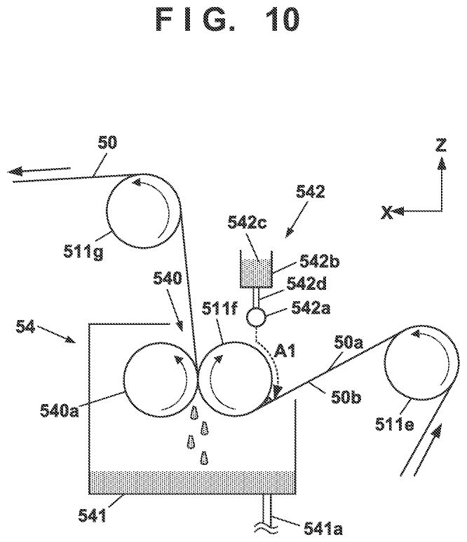

FIG. 10 will be referred to together with FIG. 8. FIG. 10 is a schematic view showing an example of the recovery unit 54. The recovery unit 54 is an apparatus that removes a liquid from the liquid absorbing member 50. The recovery unit 54 includes a removal section 540 that removes excess liquid contained in the liquid absorbing member 50, an applying section 542 that applies a liquid to the liquid absorbing member 50, and a reservoir 541 that stores the removed liquid component.

The removal section 540 removes excess liquid contained in the liquid absorbing member 50. If the liquid absorbing member 50 contains excess liquid, the amount of liquid component that can be absorbed from an ink image may decrease and the liquid absorbing performance may be degraded. However, in this embodiment, since the removal section 540 removes the excess liquid contained in the liquid absorbing member 50, it is possible to prevent a degradation in liquid absorbing performance of the liquid absorbing member 50.

In this embodiment, the removal section 540 includes the driven rotating body 511f and a driven rotating body 540a which are arranged facing each other. In this embodiment, the driven rotating body 511f and the driven rotating body 540a are driven rollers that are driven and rotated in accordance with movement of the liquid absorbing member 50. However, either or both of the driven rotating body 511f and the driven rotating body 540a may be driven by a driving source such as a motor. In addition, in this embodiment, the driven rotating body 511f and the driven rotating body 540a are arranged facing each other and configured to nip the liquid absorbing member 50. The liquid absorbing member 50 is sandwiched between the driven rotating body 540a and the driven rotating body 511f, squeezing out the liquid absorbed by the liquid absorbing member 50. In that sense, the driven rotating body 511f commonly uses a part of the recovery unit 54. It is also possible to adopt an arrangement in which either or both of the driven rotating body 511f and the driven rotating body 540a can move in the direction for releasing nipping by them.

The applying section 542 applies the liquid to the liquid absorbing member 50 before the removal section 540 removes the excess liquid contained in the liquid absorbing member 50. As described above, the removal section 540 removes the excess liquid contained in the liquid absorbing member 50, thereby preventing a degradation in liquid absorbing performance of the liquid absorbing member 50. However, it is conceivable that removing the liquid leads to thickening of the liquid absorbing member 50, resulting in a degradation in liquid absorbing performance. In this embodiment, before the excess liquid contained in the liquid absorbing member 50 is removed by the removal section 540, the applying section 542 applies the liquid to the liquid absorbing member 50. Therefore, the excess liquid is removed by the removal section 540 in a state in which the viscosity of the liquid contained in the liquid absorbing member 50 is lowered, so that thickening of the liquid absorbing member 50 after removal of the liquid can be prevented and the excess liquid can be more effectively removed from the liquid absorbing member 50. Accordingly, a degradation in liquid absorption performance of the liquid absorbing member 50 can be prevented more effectively.

In addition, it is assumed that even if the moisturizing liquid is applied to the liquid absorbing member 50 by the recovery unit 53, drying of the liquid absorbing member 50 proceeds until the liquid absorbing member 50 arrives at the recovery unit 54, so the liquid cannot be effectively removed by the removal section 540. However, in this embodiment, the applying section 542 is provided in the recovery unit 54, and the applying section 542 applies the liquid to the liquid absorbing member 50 before the removal section 540 removes the liquid contained in the liquid absorbing member 50. Accordingly, the liquid contained in the liquid absorbing member 50 can be effectively removed while preventing drying of the liquid absorbing member 50. Particularly, in this embodiment, the applying section 542 applies the liquid immediately before the excess liquid contained in the liquid absorbing member 50 is removed by the removal section 540. This can further prevent drying of the liquid absorbing member 50, so that the excess liquid can be more effectively removed from the liquid absorbing member 50. Therefore, a degradation in liquid absorption performance of the liquid absorbing member 50 can be prevented more effectively. If the liquid absorption performance of the liquid absorbing member 50 can be maintained by the presence of the recovery unit 54 the recovery unit 53 may not be provided so as to simplify the arrangement of the apparatus.

With the above arrangement, it is also possible to lower the viscosity of the liquid contained in the liquid absorbing member 50 after removal of the liquid by the removal section 540 than the viscosity of the liquid component in the ink image IM. Therefore, the liquid absorbing performance of the liquid absorbing member 50 can be maintained, and the quality of an image printed on the print medium P can be maintained.

In this embodiment, the applying section 542 includes a nozzle unit 542a that applies a liquid to the liquid absorbing member 50, and a supply portion 542d that supplies a liquid 542c from a reservoir 542b that reserves the liquid 542c to be applied by the nozzle unit 542a. The reservoir 542b may be provided inside the apparatus, or the supply portion 542d may supply the liquid 542c drawn from the external reservoir 542b to the nozzle unit 542a. The nozzle unit 542a is arranged above the driven rotating body 511f in a gravity direction, and drops the liquid 542c onto the driven rotating body 511f. The liquid 542c dropped onto the driven rotating body 511f passes a path along the outer periphery of the driven rotating body 511f as shown by an arrow Al in FIG. 10, and is applied onto the first surface 50a of the liquid absorbing member 50 located below, due to rotation of the driven rotating body 511f or by gravity. In other words, the nozzle unit 542a indirectly applies the liquid 542c to the first surface 50a of the liquid absorbing member 50 via the driven rotating body 511f. By applying the liquid 542c to the first surface 50a which contacts the ink image IM, thickening of the first surface 50a can be suppressed, and the liquid absorbing performance of the liquid absorbing member 50 can be maintained.

In addition, the liquid 542c dropped from the nozzle unit 542a moves along the outer periphery of the driven rotating body 511f, and is applied to the liquid absorbing member 50 at a position where the driven rotating body 511f contacts the liquid absorbing member 50 and a region immediately before this position. A part of the applied liquid 542c is squeezed out by the driven rotating body 540a and the driven rotating body 511f together with the liquid contained in the liquid absorbing member 50 before being conveyed to the removal section 540. In this manner, since the liquid 542c is applied to the liquid absorbing member 50 immediately before the removal section 540 removes the liquid from the liquid absorbing member 50, the liquid absorbing member 50 is less likely to get dry before being provided to the removal section after the liquid is applied, so that it is possible to remove the liquid in a state in which the viscosity of the liquid contained in the liquid absorbing member 50 is lowered compared to that before reaching the removal section 540.

In this embodiment, the liquid 542c is pressurized by a pressurizing mechanism (not shown) and dropped from the nozzle unit 542a. However, it is also possible to adopt an arrangement in which the liquid 542c is naturally dropped without providing a pressurizing mechanism or the like.

The reservoir 542b reserves the liquid 542c to be dropped from the nozzle unit 542a. The reservoir 542b is provided above the nozzle unit 542a in the gravity direction in this embodiment, but it may be provided below the nozzle unit 542a. In this case, for example, the reserved liquid 542c may be supplied to the nozzle unit 542a by a pump or the like.

For example, water may be used as the liquid 542c. The liquid 542c may contain a water-soluble organic solvent or a surfactant. The same liquid as the moisturizing liquid 532a applied to the liquid absorbing member 50 in the recovery unit 53 may be used.

The reservoir 541 captures the liquid contained in the liquid absorbing member 50 removed by the removal section 540. In this embodiment, the reservoir 541 is provided below the driven rotating body 540a in the gravity direction. Further, in this embodiment, the reservoir 541 includes an exit path 541a for draining the liquid captured in the reservoir 541 to the outside. In this embodiment, the liquid captured in the reservoir 541 is drained from the exit path 541a to the outside of the apparatus. When draining the liquid from the exit path 541a to the outside of the apparatus, for example, a pump or the like may be used.

It is also possible to adopt an arrangement in which the exit path 541a is connected to the reservoir 542b, and the liquid is circulated so that the liquid captured in the reservoir 541 is applied again from the applying section 542 to the liquid absorbing member 50. However, in such an arrangement, it is assumed to be difficult to obtain the effect of suppressing thickening of the liquid absorbing member 50 by the recovery unit 54 since the viscosity of the liquid applied from the applying section 542 to the liquid absorbing member 50 increases while the liquid circulates. In this embodiment, the liquid captured in the reservoir 541 is drained from the exit path 541a to the outside of the apparatus, and a new liquid is always supplied to the reservoir 542b. Therefore, the liquid having a lower viscosity can be supplied from the applying section 542 to the liquid absorbing member 50, so that the effect of suppressing thickening of the liquid absorbing member 50 can be further enhanced.

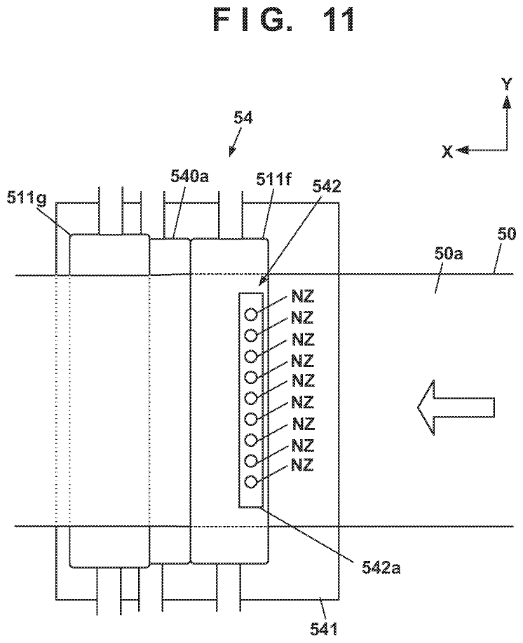

FIG. 11 is a view schematically showing a relationship between the length in a widthwise direction (Y direction) of the liquid absorbing member 50 and that of each component of the recovery unit 54. Note that for the sake of descriptive convenience, a part of the arrangement is omitted, and the positional relationship in the X direction and the Z direction is schematically shown. The arrow in FIG. 11 indicates the moving direction of the liquid absorbing member 50.

In this embodiment, the length in the Y direction of the reservoir 541 is longer than the length in the Y direction of the liquid absorbing member 50. This makes it possible to thoroughly capture the liquid removed from the liquid absorbing member 50. Further, in this embodiment, the length in the Y direction of the driven rotating body 511f and that of the driven rotating body 540a are longer than the length in the Y direction of the liquid absorbing member 50. Thus, the entire region in the Y direction of the liquid absorbing member 50 is nipped by the driven rotating body 511f and the driven rotating body 540a, so that the excess liquid contained in the liquid absorbing member 50 can be removed over the entire region in the Y direction.

Furthermore, in this embodiment, the nozzle unit 542a is arranged to extend in the Y direction as a whole, and includes a plurality of nozzles NZ arrayed at predetermined intervals in the Y direction and capable of discharging a liquid. In other words, the applying section 542 includes a plurality of liquid discharge portions arrayed in the Y direction (widthwise direction) of the liquid absorbing member 50. This enables the applying section 542 to apply the liquid 542c to the liquid absorbing member 50 evenly in the Y direction. Further, in this embodiment, among the plurality of arrayed nozzles NZ, the nozzles NZ located on both outer sides in the Y direction are arranged within the width in the Y direction of the liquid absorbing member 50. This enables the liquid 542c dropped from each nozzle NZ to be thoroughly applied to the liquid absorbing member 50.

Note that in this embodiment, the plurality of nozzles NZ are arrayed in the widthwise direction of the liquid absorbing member, but the applying section 542 may be configured such that, for example, the liquid is discharged in a curtain shape from a slot-shaped discharge port long in the Y direction (widthwise direction).

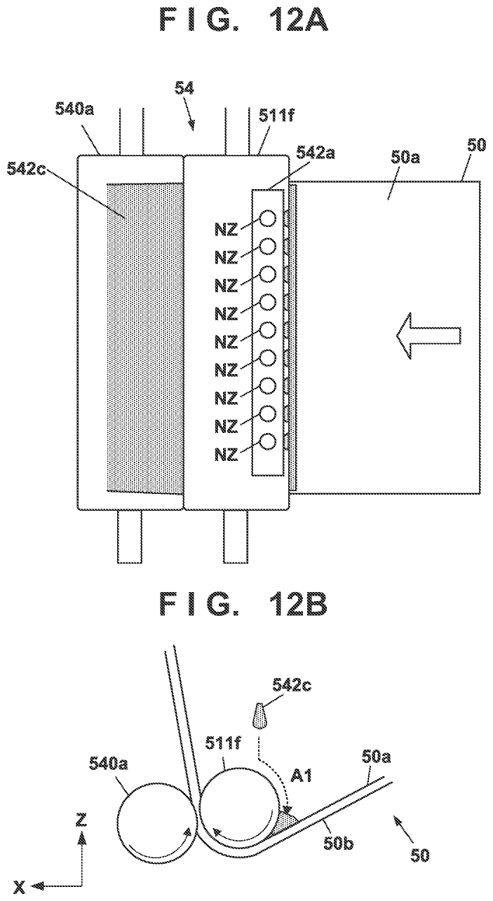

FIGS. 12A and 12B schematically show the spread of the liquid 542c when the liquid is applied to the liquid absorbing member 50. FIG. 12A is a view showing the spread of the liquid 542c when the liquid 542c is dropped onto the driven rotating body 511f by the nozzle unit 542a as seen from the Z direction, and FIG. 12B is a view as seen from the Y direction. Note that, for the sake of descriptive convenience, the positional relationship among respective components is schematically shown, and a part of the arrangement is omitted. Hatching in FIGS. 12A and 12B indicates the liquid.

The liquid 542c dropped from each nozzle NZ of the nozzle unit 542a is applied to the first surface 50a of the liquid absorbing member 50 via the driven rotating body 511f. At this time, since the plurality of nozzles NZ are arrayed in the Y direction at predetermined intervals, the liquid 542c may not be dropped uniformly in the Y direction such that the amount of the liquid 542c immediately below each nozzle NZ is large. However, the liquid 542c is blocked before nipping by the driven rotating body 511f and the driven rotating body 540a and spreads in the Y direction, so that the liquid 542c is evenly applied to the liquid absorbing member 50. That is, since the liquid 542c spreads in the Y direction due to the driven rotating body 511f and the driven rotating body 540a, the liquid 542c can be evenly applied to the liquid absorbing member 50.

Further, in this embodiment, since the liquid 542c is dropped onto the driven rotating body 511f, the driven rotating body 511f itself is also cleaned, so that the image quality of an image printed on a print medium can be maintained.

Further, in this embodiment, the nozzle unit 542a drops the liquid 542c onto the driven rotating body 511f, but an arrangement in which the nozzle unit 542a applies the liquid 542c to the driven rotating body 540a can also be adopted. In the case of applying the liquid 542c to the driven rotating body 540a, a roller coating method can be used.

Note that when the suppression effect of the viscosity raise of the liquid absorbing member 50 was experimented with using this embodiment, the suppression effect was confirmed. In this experiment, the viscosity of the liquid collected in the removal section 540 after printing 500 sheets was compared between a case in which the recovery unit 54 includes the applying section 542 and a case in which the recovery unit 54 does not include the applying section 542.

After printing 500 sheets, in the case of not including the applying section 542, the viscosity of the collected liquid increased from 0.9 cP (centipoise) at the start to 2.1 cP. On the other hand, in the case of including the applying section 542, the change was small compared to the viscosity of the initial collection liquid, and the viscosity increased only from 0.9 cP at the start to 1.1 cP. Note that in the experiment, pure water (0.9 cP) was used as the liquid (low viscosity liquid). In this way, the effect of liquid application by the applying section 542 was confirmed by the experiment.

In order to maintain the image quality, at the time of absorbing the liquid from an ink image by the liquid absorbing member 50 having passed through the removal section 540, the viscosity of the liquid component contained in the portion of the liquid absorbing member 50 in contact with the ink image may be lower than the viscosity of the liquid component in the ink image to be absorbed. Therefore, it may be applied that a liquid having a viscosity lower than that of the liquid component in the ink image to be absorbed.

The relationship between the surfaces of the liquid absorbing member 50, application of the liquid, and removal of the excess liquid will be described next. In the recovery unit 54, the second surface 50b of the liquid absorbing member 50 is located on the lower side in the gravity direction, and the first surface 50a is located on the upper side in the gravity direction. Therefore, it is more likely that the liquid is squeezed out of the side of the second surface 50b than of the side of the first surface 50a and falls due to gravity. It is possible to ensure a region for absorbing the liquid component in the reverse layer and recover the liquid absorption performance of the liquid absorbing member 50 by promoting removal of the liquid from the second surface 50b. It is also possible to suppress drying of the first surface 50a to which the liquid 532a is applied by the recovery unit 53.

Further, in this embodiment, after the moisturizing liquid 532a is applied to the first surface 50a of the liquid absorbing member 50 in the recovery unit 53, the liquid 542c is further applied to the first surface 50a in the recovery unit 54. Therefore, thickening of the liquid absorbing member 50 can be further suppressed, and the liquid absorption performance of the liquid absorbing member 50 can be recovered more efficiently.

The materials of the members of the driven rotating body 511f and the driven rotating body 540a are not particularly limited. From the viewpoint of the amount of squeezing, the driven rotating body 540a contacting the second surface 50b of the liquid absorbing member 50 may be softer than the driven rotating body 511f contacting the first surface 50a of the liquid absorbing member 50. Further, from the viewpoint of the conveyance property of the liquid absorbing member 50, surface treatment may be done or a layer may be provided on the obverse layer in consideration of the friction with the liquid absorbing member 50.

As described above, in this embodiment, an arrangement is adopted in which the recovery units 52, 53, and 54 perform recovery processing in the processing order of the removal of dust particles, moisturizing, and the removal of the liquid component from an upstream side to a downstream side in the rotating and moving direction of the liquid absorbing member 50. The processing order is not limited to this. According to the processing order of this embodiment, however, the recovery unit 53 moisturizes the first surface 50a after the recovery unit 52 cleans the first surface 50a, making it possible to promote the removal of dust particles and an improvement in moisture retention. Moreover, the recovery unit 54 removes the liquid component relatively on the downstream side, making it possible to remove the liquid component in a place where the second surface 50b moves at a high position in the gravity direction. This has the advantage that the removed liquid component is easily collected by using gravity.

The preprocessing unit 55 will be described next. The preprocessing unit 55 is an apparatus that mainly performs preprocessing for making full use of the liquid absorption performance of the liquid absorbing member 50 in a short time at the start of the operation of the printing system 1 or the like. In this embodiment, a preprocessing liquid is applied to the first surface 50a of the liquid absorbing member 50, improving a rise in liquid absorption performance. For example, when an obverse layer is made of the water-repellent material, the preprocessing liquid can use a surfactant. F-444 (trade name, available from DIC) or ZonylFS3100 (trade name, available from DuPont) of a fluorochemical surfactant is given as the surfactant. Further, CapstoneFS-3100 (trade name, available from The Chemours CompanyLCC), BYK349 (trade name, available from BYK) which is a silicone surfactant, or the like is also given as the surfactant.

The preprocessing unit 55 includes an application roller 551, a reservoir 552, a support member 553, and a moving mechanism 554. The support member 553 supports the application roller 551 rotatably about the axis in the Y direction and also supports the reservoir 552. A preprocessing liquid 552a is reserved in the reservoir 552. The application roller 551 is partially immersed in the preprocessing liquid 552a. The moving mechanism 554 is a mechanism which moves the support member 553 and is, for example, an electrically-driven cylinder. The application roller 551 and the reservoir 552 also move when the support member 553 moves. They move in the direction of an arrow d5 (here, the horizontal direction) between an application position at which the application roller 551 contacts the liquid absorbing member 50 and a retracted position at which the application roller 551 is separated from the liquid absorbing member 50. FIG. 8 shows a state in which the application roller 551 is located at the retracted position. The application roller 551 can move to the application position at the start of the operation of the printing system 1 or periodically (for example, in the unit of the number of print media P to be processed).

The application roller 551 is arranged facing the driven rotating body 511e, and configured such that the liquid absorbing member 50 is nipped by the application roller 551 and the driven rotating body 511e when the application roller 551 moves to the application position. The application roller 551 rotates in accordance with rotation and movement of the liquid absorbing member 50. The peripheral surface of the application roller 551 is formed by, for example, rubber and supplies the preprocessing liquid 552a reserved in the reservoir 552 to the first surface 50a of the liquid absorbing member 50 by drawing the preprocessing liquid 552a.

With this arrangement, the absorbing unit 5B absorbs the liquid component from the ink image IM on the transfer member 2 by the liquid absorbing member 50. The liquid component can be absorbed from the ink image IM continuously by absorbing the liquid component simultaneously with cyclical rotation and movement of the liquid absorbing member 50. In addition, the liquid absorption performance of the liquid absorbing member 50 can be maintained for a longer period of time by providing the recovery unit 52, the recovery unit 53, and the recovery unit 54, making it possible to prolong a replacement cycle of the liquid absorbing member 50.

The detection unit 56 is a sensor that detects passage of a predetermined portion of the liquid absorbing member 50 at a predetermined position on the moving path of the liquid absorbing member 50. In this embodiment, the detection unit 56 is arranged at a position comparatively near the liquid absorbing position A. In one round of the moving path of the liquid absorbing member 50 with the liquid absorbing position A as a starting point and an ending point, the position of the detection unit 56 can be a position on a side closer to the ending point than an intermediate point or a position on a side closer to the ending point than an intermediate point between the intermediate point and the ending point.

It is also possible to adopt an arrangement in which the nozzle unit 542a discharges the liquid 542c directly to the first surface 50a or the second surface 50b of the liquid absorbing member 50 at a position upstream of the driven rotating body 540a in the moving direction of the liquid absorbing member 50. Even in such an arrangement, the liquid 542c is blocked by nipping by the driven rotating body 511f and the driven rotating body 540a and spreads in the Y direction, so that the liquid 542c is evenly applied to the liquid absorbing member 50.

### Second Embodiment

In the first embodiment, the applying section 542 applies the liquid to the liquid absorbing member 50 via the driven rotating body 511f. In the second embodiment, however, an applying section 1342 directly applies a liquid to a liquid absorbing member 50. Note that in the following description and drawings, the components similar to those of the first embodiment are denoted by the same reference numerals, and the description thereof will be omitted.

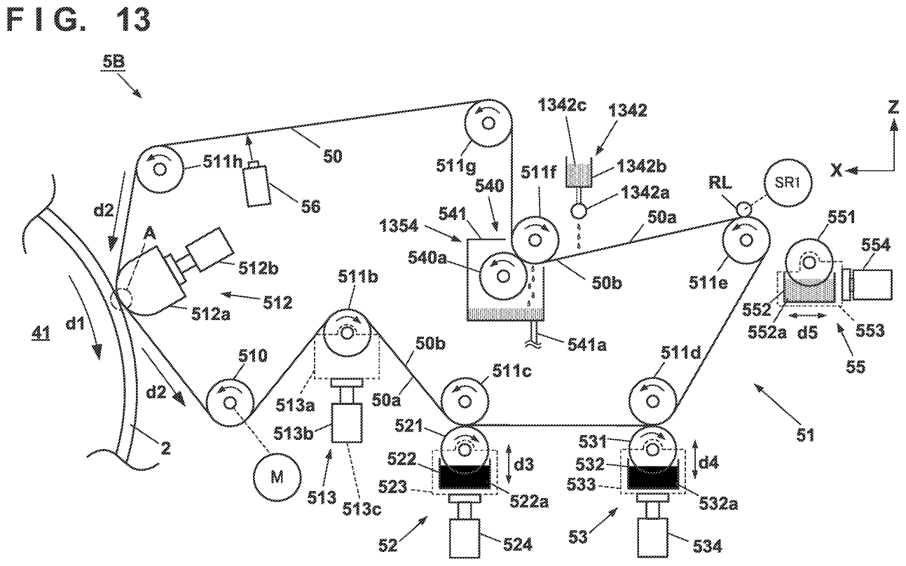

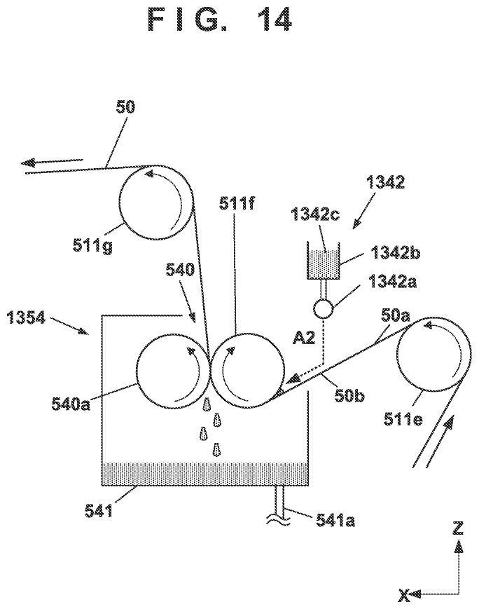

FIG. 13 is a schematic view showing an example of an absorbing unit 5B in the second embodiment. FIG. 14 is a schematic view showing an example of a recovery unit 1354. The recovery unit 1354 includes a removal section 540 that removes excess liquid contained in the liquid absorbing member 50, an applying section 1342 that applies a liquid to the liquid absorbing member 50, and a reservoir 541 that stores the removed liquid component.

The applying section 1342 directly applies the liquid to the liquid absorbing member 50 before the removal section 540 removes the excess liquid contained in the liquid absorbing member 50. In this embodiment, the applying section 1342 includes a nozzle unit 1342a that applies a liquid to the liquid absorbing member 50, and a reservoir 1342b that stores a liquid 1342c to be applied by the nozzle unit 1342a. The nozzle unit 1342a is arranged above the liquid absorbing member 50 in a gravity direction, and drops the liquid 1342c to a first surface 50a of the liquid absorbing member 50 at a position upstream of a driven rotating body 511f in the moving direction of the liquid absorbing member 50. The liquid 1342c is directly applied to the liquid absorbing member 50, as shown by an arrow A2 in FIG. 14.

With such an arrangement, the excess liquid is removed by the removal section 540 in a state in which the viscosity of the liquid contained in the liquid absorbing member 50 is lowered, so that thickening of the liquid absorbing member 50 after removal of the liquid can be prevented and the excess liquid can be more effectively removed from the liquid absorbing member 50. Therefore, the liquid absorption performance of the liquid absorbing member 50 can be recovered more effectively.

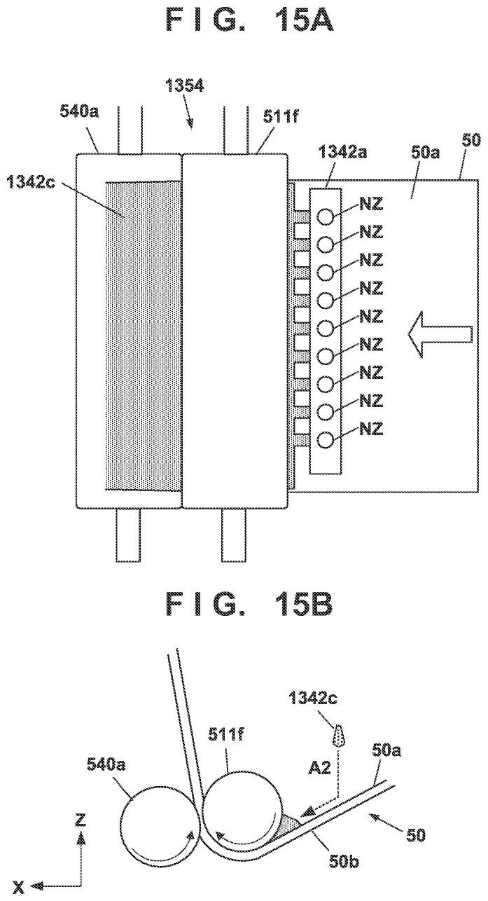

FIGS. 15A and 15B schematically show the spread of the liquid 1342c when the liquid 1342c is applied to the liquid absorbing member 50 in the second embodiment, in which FIG. 15A is a view as seen from the Z direction and FIG. 15B is a view as seen from the Y direction. Note that, for the sake of descriptive convenience, the positional relationship among respective components is schematically shown, and a part of the arrangement is omitted. Hatching in FIGS. 15A and 15B indicates the liquid 1342c.

The liquid 1342c dropped from each nozzle NZ of the nozzle unit 1342a is applied directly to the first surface 50a of the liquid absorbing member 50. At this time, since the plurality of nozzles NZ are arrayed in the Y direction at predetermined intervals, the liquid 1342c may not be dropped uniformly in the Y direction such that the amount of the liquid 1342c immediately below each nozzle NZ is large. However, not all of the liquid 1342c applied to the liquid absorbing member 50 is absorbed immediately by the first surface 50a, and a portion of the liquid 1342c remaining on the liquid absorbing member 50 moves downstream with the liquid absorbing member 50. The liquid 1342c moving downstream is then blocked before nipping by the driven rotating body 511f and the driven rotating body 540a and spreads in the Y direction, so that the liquid 1342c is evenly applied to the liquid absorbing member 50. That is, since the liquid 1342c spreads in the Y direction due to the driven rotating body 511f and the driven rotating body 540a, the liquid 1342c can be evenly applied to the liquid absorbing member 50.

In one embodiment, the liquid absorbing member 50 is provided an inclined area. The inclined area is inclined from upstream side with respect to the direction of rotation and movement to a portion in contact with the driven rotating body 511f. The applying section 1342 applies the liquid 1342c to the inclined area. In one embodiment, the driven rotating body 511e contacts the second surface 50b and the driven rotating body 511e arranged above the driven rotating body 511f with respect to a gravitational direction. The inclined area of the liquid absorbing member 50 is an area between the driven rotating body 511e and the driven rotating body 511f.

In this embodiment, the liquid 1342c is pressurized by a pressurizing mechanism (not shown) and dropped from the nozzle unit 1342a. However, it is also possible to adopt an arrangement in which the liquid 1342c is naturally dropped without providing a pressurizing mechanism or the like. Also, for example, a roller-coating liquid supply mechanism may be provided upstream of the driven rotating body 540a in the moving direction of the liquid absorbing member 50 to apply the liquid 1342c directly to the surface of the liquid absorbing member 50.

### Third Embodiment

In the first and second embodiments, the removal section 540 squeezes out the liquid absorbed by the liquid absorbing member 50 by nipping the liquid absorbing member 50 by the driven rotating body 540a and the driven rotating body 511f. In the third embodiment, however, the liquid contained in a liquid absorbing member 50 is removed by blowing air onto the liquid absorbing member. Note that in the following description and drawings, the components similar to those of the first and second embodiments are denoted by the same reference numerals, and the description thereof will be omitted.

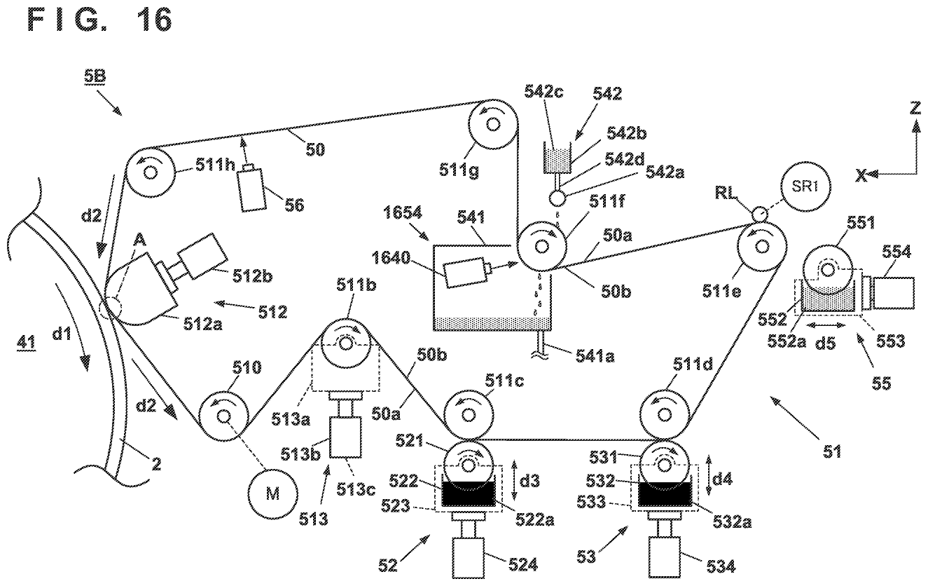

FIG. 16 is a schematic view showing an example of an absorbing unit 5B in the third embodiment. A recovery unit 1654 includes a removal section 1640 that removes excess liquid contained in the liquid absorbing member 50, an applying section 542 that applies a liquid to the liquid absorbing member 50, and a reservoir 541 that stores the removed liquid component.

The removal section 1640 removes excess liquid contained in the liquid absorbing member 50. If the liquid absorbing member 50 contains excess liquid, the amount of liquid component that can be absorbed from an ink image may decrease and the liquid absorbing performance may be degraded. However, in this embodiment, since the removal section 1640 removes the excess liquid contained in the liquid absorbing member 50, it is possible to prevent a degradation in liquid absorbing performance of the liquid absorbing member 50.

In this embodiment, the removal section 1640 is a nozzle that ejects air. The removal section 1640 blows air onto a second surface 50b of the liquid absorbing member 50 and removes, by blowing off, the liquid absorbed on the side of the second surface 50b of the liquid absorbing member 50 by the pressure of the blown air. By removing the excess liquid contained in the liquid absorbing member 50 from the side of the second surface 50b, it is possible to recover the liquid absorption performance of the liquid absorbing member 50 while suppressing drying of a first surface 50a.

Note that in this embodiment, the removal section 1640 is formed only by the nozzle that ejects air. However, it is also possible to adopt a combination of the arrangement in which the liquid contained in the liquid absorbing member 50 is removed by the driven rotating body 511f and the driven rotating body 540a as described in the first and second embodiments and the arrangement in which the nozzle ejects air as in this embodiment.

### Another Embodiment

In the above embodiments, the print unit 3 includes the plurality of printheads 30. However, an arrangement may include one printhead 30. The printhead 30 need not be a full-line head but may be of a serial type that forms an ink image by discharging ink from the printhead 30 while a carriage that mounts the printhead 30 moves in a Y direction.

The printing system 1 uses a transfer member as an ink receiving medium, and transfers an ink image formed by the ink discharged onto the transfer member to a print medium. However, the printing system 1 may use a print medium as an ink receiving medium and discharge ink from a printhead onto the print medium so that the ink is directly applied to the print medium, and an absorbing unit 5B may absorb a liquid component from an ink image on the print medium.

A conveyance mechanism of a print medium P may adopt another method such as a method of nipping and conveying the print medium P by a pair of rollers. In the method of conveying the print medium P by the pair of rollers or the like, a roll sheet may be used as the print medium P, and a printed product P′ may be formed by cutting the roll sheet after transfer.

In the above embodiments, the transfer member 2 is provided on the outer peripheral surface of the transfer cylinder 41. However, another method such as a method of forming a transfer member 2 into an endless swath and cyclically rotating and moving it may be used.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefits of Japanese Patent Application No. 2018-148721, filed Aug. 7, 2018, which is hereby incorporated by reference herein in its entirety.

What is claimed is:

1. A printing apparatus comprising:
a transfer member configured to rotate and move cyclically;
a transfer unit configured to transfer an image formed on the transfer member to a print medium; and
a liquid absorbing unit configured to absorb a liquid component from the image on the transfer member before transfer by the transfer unit,
wherein the liquid absorbing unit comprises:
a liquid absorbing member configured to have a first surface contacting the image and a second surface opposite to the first surface;
a moving unit configured to rotate and move the liquid absorbing member cyclically;
a liquid removal section configured to include a first rotating body in contact with the first surface and a second rotating body in contact with the second surface, wherein the first rotating body and the second rotating body nip the liquid absorbing member, wherein the liquid removal section removes a liquid contained in the liquid absorbing member from a nipped portion by the first rotating body and the second rotating body; and
a liquid applying section, arranged above the liquid absorbing member with respect to a gravitational direction, configured to apply a liquid to a position on the first surface, wherein the position is on an upstream side of the nipped portion with respect to a direction of rotation and movement of the liquid absorbing member.

2. The printing apparatus according to claim 1, wherein the liquid applying section applies a liquid to the liquid absorbing member before removal by the removal section.

3. The printing apparatus according to claim 1, wherein the removal section removes a liquid from the liquid absorbing member containing the liquid applied by the liquid applying section.

4. The printing apparatus according to claim 1, wherein the liquid applying section applies water, a liquid containing a water-soluble organic solvent or a surfactant, or a moisturizing liquid to the first rotating body or the second rotating body.

5. The printing apparatus according to claim 1, wherein the first surface contacts the transfer member and absorbs the liquid component contained in the image, and the liquid applying section applies the liquid to the first surface.

6. The printing apparatus according to claim 1, wherein the liquid absorbing unit further includes a reservoir configured to receive and reserve the liquid removed from the liquid absorbing member by the removal section.

7. The printing apparatus according to claim 6, wherein the reservoir comprises an exit path configured to drain the liquid reserved in the reservoir to the outside of the apparatus, and
the liquid absorbing unit comprises another reservoir configured to reserve the liquid to be applied to the liquid absorbing member by the liquid applying section.

8. The printing apparatus according to claim 6, wherein a length in a widthwise direction of the reservoir is larger than a length in the widthwise direction of the liquid absorbing member.

9. The printing apparatus according to claim 1, wherein each length in a widthwise direction of the first rotating body and the second rotating body is larger than a length in the widthwise direction of the liquid absorbing member.

10. The printing apparatus according to claim 1, wherein the liquid applying section comprises a plurality of liquid discharge portions arrayed in a widthwise direction of the liquid absorbing member.

11. The printing apparatus according to claim 10, wherein the plurality of liquid discharge portions are arranged within a width of the liquid absorbing member.

12. The printing apparatus according to claim 1, wherein the liquid absorbing member is provided an inclined area that is inclined from the upstream side with respect to the direction of rotation and movement to a portion in contact with the first rotating body, and wherein the liquid applying section applies a liquid to the inclined area.

13. The printing apparatus according to claim 12, wherein the liquid absorbing unit has a third rotating body in contact with the second surface and arranged above the first rotating body with respect to a gravitational direction, wherein the inclined area of the liquid absorbing member is an area between the third rotating body and the first body.

14. The printing apparatus according to claim 1, wherein a viscosity of a liquid contained in the liquid absorbing member after the liquid is removed by the liquid removal section is lower than a viscosity of a liquid component in the image.

15. The printing apparatus according to claim 1, further comprising a liquid application unit configured to apply a liquid to the liquid absorbing member at a position which is between a position where the liquid component is absorbed from the image and the liquid removal section and which is upstream of the liquid removal section and the liquid applying section in a moving direction of the liquid absorbing member.

16. A printing method comprising:
transferring an image formed on the transfer member to a print medium;
absorbing a liquid by absorbing a liquid component from the image on the transfer member before transfer by the transferring,
wherein the absorbing the liquid comprises:
moving a liquid absorbing member to rotate and move cyclically;
removing a liquid contained in the liquid absorbing member from a nipped portion by a first and a second rotating body, wherein the first rotating body contacts a first surface of the liquid absorbing member and the second rotating body contacts a second surface of the liquid absorbing member, wherein the first surface contacts the image and the second surface is opposite to the first surface,
applying a liquid to a position on the first surface, wherein the position is on an upstream side of the nipped portion with respect to a direction of rotation and movement of the liquid absorbing member.
